(19) United States
(12) Patent Application Publication
(10) Pub. No.: US 2004/0134321 A1
(43) Pub. Date: Jul. 15, 2004

(54) Guiding roller and adjusting method

(76) Inventor: Anton Weis, Lorsch (DE)

Correspondence Address: Douglas R Hanscom, Jones Tullar & Cooper, Eads Station, PO Box 2266, Arlington, VA, 22202, US

(21) Appl. No.: 10/469,982

(22) PCT Filed: Mar. 6, 2002
(86) PCT No.: PCT/DE02/00804

(30) Foreign Application Priority Data
Mar. 15, 2001 (DE) 101 12 416.3

(51) Int. Cl. B65H 23/32; B26D 7/00

(52) U.S. Cl. 83/99; 83/162; 83/425.3; 226/97.1

(57) ABSTRACT

A guiding roller for reversing a material web comprises a lateral surface provided with holes (08) over at least a portion of the periphery thereof and comprises an inner space, which is supplied with compressed air and inside of which at least one piston (18, 19, 22, 23) for selectively occluding the holes can be axial displaced. The guiding roller additionally comprises a motor for displacing the piston and is provided with a control circuit that operates the motor whereby causing the piston to occupy a specified position that is defined by a control signal supplied to the control circuit. The guiding roller can pivot 90° on the frame about a pivotal axis that is perpendicular to the longitudinal axis of the roller. A gear mechanism couples a rotational movement of the piston about the axis to the pivotal movement of the guiding roller.

The invention relates to a guide roller for guiding a web of material and a method for adjustment in accordance with the preambles of claims 1 or 26.

Guide rollers of this type are used in particular at the output side of a rotary printing press if it is required to reroute several partial webs into which a paper web imprinted in the rotary printing press has been cut and which leave, lying next to each other, a cutting device, in such a way that they can be placed on top of each other, folded, if necessary, and further processed.

DE 34 36 870 C1 discloses a turning bar with an axially displaceable piston.

Turning bars, which are embodied with an interior which can be supplied with compressed air, are known from U.S. Pat. No. 5,464,143 A. The jacket of the turning bars is provided with holes over at least a part of its circumference, through which air can escape from the interior in order to form an air cushion between the turning bar and the web of material.

Pistons can be axially displaced in the interior of these known turning bars which, depending on their position inside the turning bar, block a more or less large number of holes in order to match the width of the air cushion generated on the turning bar to the width of the web of material to be rerouted.

Such a matching is necessary, because compressed air escaping through the holes in the shell not covered by the web of material leads to an undesirable weakening of the air cushion generated by the holes covered by the web of material, so that the effect of the air cushion can be insufficient in the case of a narrow web of material. Moreover, the air currents exiting through the uncovered holes can interfere with the running of adjacent webs of material.

However, by means of the turning bar known from the above mentioned document it is not possible to achieve an optimum matching of the shape of the air cushion to the course of the web of material. The reason for this is that the piston interiors are planar, while the edge of a web of material on the shell of the turning bar which typically is to be deflected by 90° follows a helical line. If the piston is set in such a way that all holes not covered by the web of material are blocked, triangular zones result in the edge areas of the web of material, in which the web is not completely supported by an air cushion. If the pistons are set in such a way that the entire web is supported by an air cushion, holes supplied with compressed air necessarily remain uncovered.

To avoid this problem, pistons are used whose side facing the interior is not planar, but instead has edges whose courses respectively correspond on one half of the circumference to a right-turning, and on the other half to a left-turning helical line. The pistons can be rotated around their axes within the turning bar so that, depending on the direction in which the web of material is rerouted, one or the other of the two helically-shaped edges can be turned toward the perforated portion of the circumference of the outside around which the web of material to be rerouted is looped.

By means of a piston shaped in this way it is possible to optimally use the compressed air available, the web of material is homogeneously supported by an air cushion over its entire width, and the escape of air flows from uncovered holes is prevented.

In order to make use of the advantages of the piston described in the above mentioned U.S. patent, as well as those of the piston described here, every time the turning bar is used for rerouting a web of material of a different width it is necessary to match the position of the pistons exactly to this width. Even if, instead of the width, only the direction of rerouting the web of material is changed, this can require a repositioning of the pistons. This process is very labor-intensive and arduous, because the pistons are not visible inside the shell of the turning bar. Although an operator can possible look through the holes as long as no web is conducted over the turning bar in order to determine whether or not a hole is blocked by a piston, as soon as the web is conducted over the turning bar there is no longer an opportunity to check whether all holes covered by the web are indeed free, so that the air cushion is generated over the required width.

It is the object of the invention to produce a guide roller which can be charged with compressed air, and a method for adjusting the same.

In accordance with the invention, this object is attained by means of the characteristics of claim 1 or 26.

The advantages to be obtained by means of the invention consist in particular in that a matching of the position of the pistons to the width, or the position of a web of material on the guide roller can take place rapidly and definitely. Even the matching of the position of the pistons with a displacement of the web while the latter is running is easily possible.

To obtain these advantages, a motor for displacing the piston and a control circuit are provided, which operates the motor in such a way that the piston takes up a desired position, which is determined by a control signal supplied by the control circuit.

Two types of signals in particular are considered as the control signal for the control circuit, for one a quantitative signal, i.e. a signal which can be assigned a numerical value and makes it possible for the control circuit to operate the motor long enough until the piston has achieved a position corresponding to the numerical value, on the other hand a signal with at least two discrete states, one of which can be called a “prohibited”, and the other a “permitted” state, in which case the control can consist in operating the motor until the signal changes to the “permitted” state.

The first type of control signal is particularly suited for being picked up at a device which is located upstream of the guide roller and processes the web of material, such as a cutting tool, either by measuring the position of an installation which determines the position of a web edge, or directly by derivation from a control signal which determines the position of such an installation.

It is also possible to determine the position of an edge of the web of material directly by means of a sensor, or to predetermine the desired value from a memory device, for example a control console.

A control signal of the second type can preferably be generated with the aid of a movable detector, which is coupled to the respective position of the piston for detecting the position of the web edge. In this case the coupling can contain a mechanical connection between the piston and the detector; however, a coupling by mechanical control means can be considered, in particular if the detector is distantly arranged along the path of the web of material.

A rapid and controlled adaptability of the piston position is particularly important in connection with a pivotable guide roller permitting the selective deflection of the web of material in two different directions. The process of positioning the piston can be completely automated in this way, which further simplifies the adaptation to various web widths, and possibly deflection directions.

A further advantage lies in that following the pivoting of the guide roller a separate work step of turning the piston for adapting the course of its edge to the course of the web edges can be omitted.

To prevent the escape of air through the slit, a sealing tape being pressed against the edges of the slit by the air pressure can advantageously be provided. In order to prevent an interference of the movement of the support by means of the sealing tape, the latter is preferably coupled to the piston and can be displaced in front of the slit.

Alternatively the detector can also be applied inside the piston for detecting the presence or absence of the web of material in front of one of the holes.

If the guide roller can be pivoted by 90° around an axis which is perpendicular in respect to its longitudinal axis in order to selectively deflect the web of material in opposite directions, the edges of the web of material describe a left-turning or a right-turning helical line on the surface of the guide roller, depending on the direction of the deflection. By means of an axial rotation of the pistons it is always possible to bring the area of the piston edge, whose direction of rotation corresponds to that of the web edge, into contact with the perforated area of the surface in order to achieve in this way a course of the edge of the piston which is congruent with the course of the web edge.

To match the rotational position of the pistons rapidly to the respective deflection direction, the axial rotation of the pistons is preferably coupled to the pivot movement of the guide roller by means of a gear.

Exemplary embodiments of the invention are represented in the drawings and will be described in greater detail in what follows.

Shown are in:

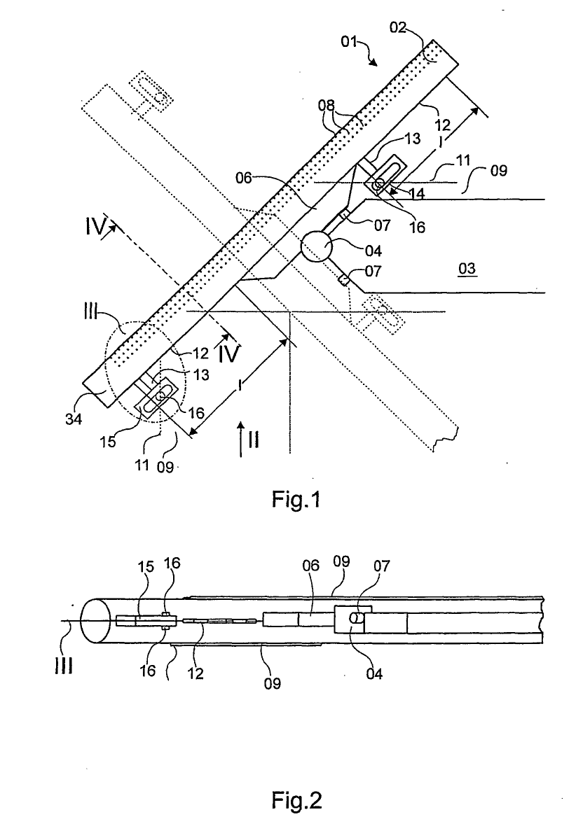

FIG. 1, a schematic view from above on the guide roller,

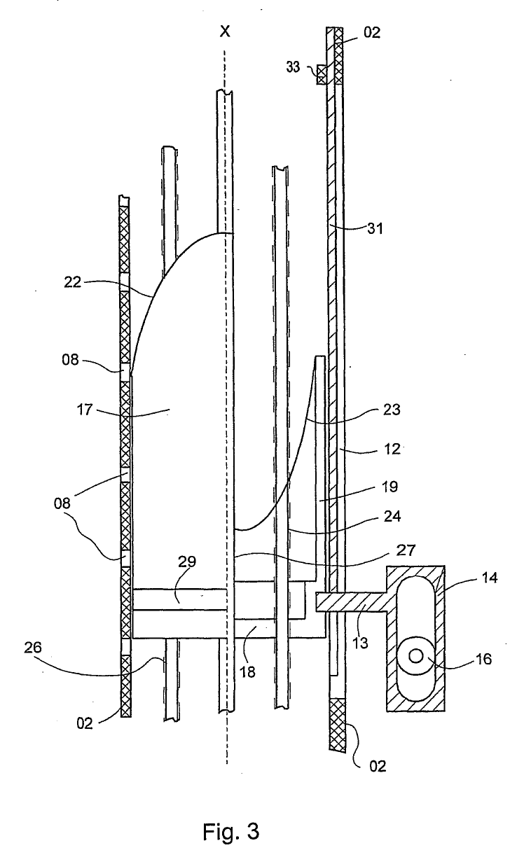

FIG. 2, a lateral view of the guide roller in FIG. 1 in the direction of the arrow II,

FIG. 3, a partial section through the area of the guide roller identified by III in FIG. 1,

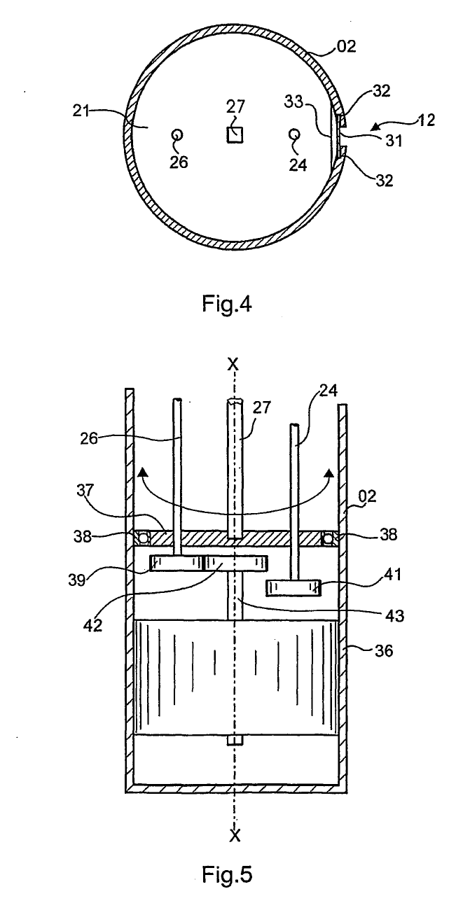

FIG. 4, a cross section through the guide roller along the line IV-IV in FIG. 1,

FIG. 5, a sectional view through the end area of the guide roller in FIG. 1,

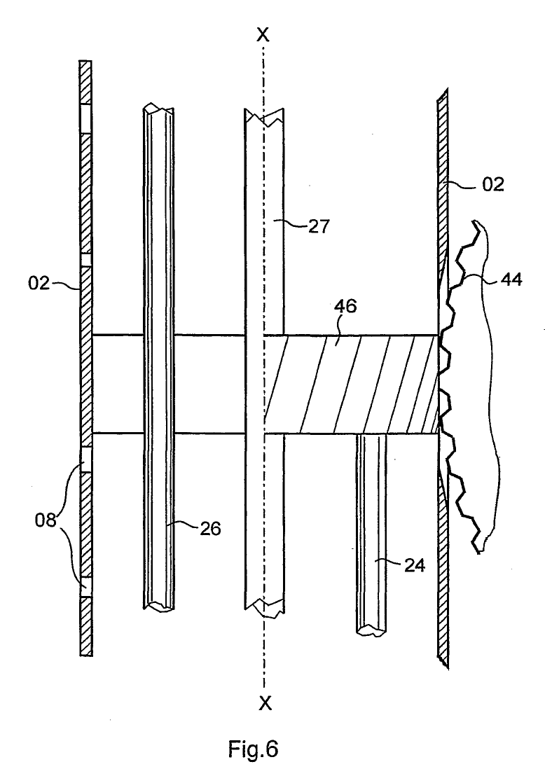

FIG. 6, an axial section through the center areas of the guide roller,

FIG. 7, a sectional view analogous to the one in FIG. 5 through the end area of a guide roller in accordance with a second embodiment,

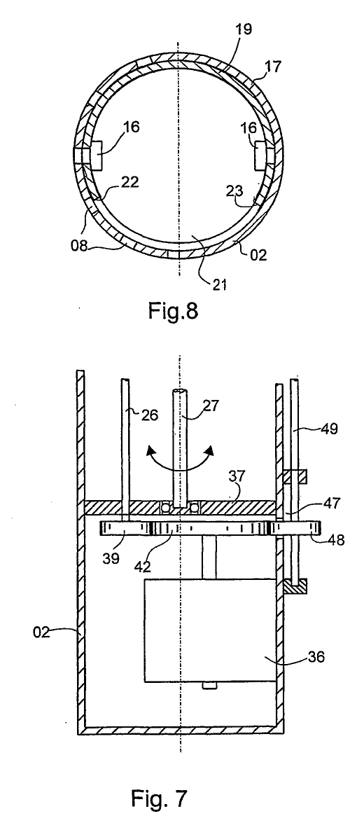

FIG. 8, a cross section through a guide roller in accordance with a third embodiment,

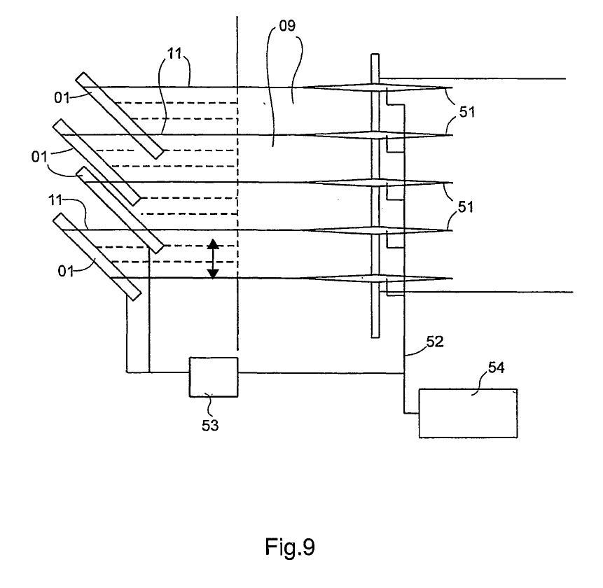

FIG. 9, a schematic representation of guide rollers and their control.

The guide roller, for example a turning bar 01, shown in a view from above in FIG. 1, is a cylindrical hollow body, which is connected with a frame (not represented) by means of a support arm 03 acting approximately on the center of its jacket 02. The support arm 03 has a joint 04, which permits a pivot movement of the turning bar 01 over an angle of 90° around an axis which extends perpendicularly to the plane of FIG. 1. The turning bar 01 is connected with the joint 04 by means of a connecting piece 06 which, in the end positions of the pivot movement freedom of the turning bar 01, comes into contact with respectively one of two stops 07 of the support arm 03. The length of the stops 07 is adjustable in order to be able to adjust the freedom of movement of the turning bar to exactly 90°.

A compressed air feed line (not represented) extends through the support arm 03, the joint 04 and the connecting piece 06, through which an interior chamber of the turning bar 01 is supplied with compressed air. On the one hand, this interior chamber is bordered by the jacket 02 and on the other by two blocking elements, for example pistons 17, which are axially displaceable inside the jacket 02 and whose structure will be explained in greater detail in connection with FIG. 3. The jacket 02 is provided on its half facing away from the connecting piece 06 with a regular arrangement of holes 08, through which compressed air can escape from the interior chamber in order to form an air cushion for a web of material 09 deflected on the turning bar 01. In FIG. 1 this web of material 09 is shown as being transparent, its edges 11 are represented as dashed lines.

On the back of the jacket 02 facing away from the holes 08, two slits 12 of a length 1 are embodied in the longitudinal direction on both sides of the connecting piece, one of which can be seen in a lateral view in FIG. 2. This FIG. 2 represents a plan view of the turning bar 01 in the direction of the arrow II in FIG. 1. A rod 13, which connects a detector holder 14 or 15 with one of the two already mentioned pistons 17 in the interior of the turning bar 01, extends through each of the two slits 12. In this case the detector holder 14 is in the shape of a frame with an elongated hole, in which a detector unit of two photoelectric cells 16 is held adjustably parallel with the longitudinal axis of the turning bar 01. As can be seen in FIG. 2, one of the two photoelectric cells 16 is oriented toward the top, the other toward the bottom. In the position represented in FIG. 1, the downward oriented photoelectric cell 16 of the detector holder 15 detects an edge 11 of the outgoing web of material 09. The upward oriented photoelectric cell 16 in the detector holder 14 detects an edge 11 of the incoming web of material 09.

When the turning bar 01 is pivoted out of its end position shown in solid lines in FIG. 1 by 90° into its other end position shown by dashed lines, the upward oriented photoelectric cell 16 of the detector holder 15 detects an incoming edge 11, and the downward oriented photoelectric cell 16 of the detector holder 15 detects an outgoing edge 11.

FIG. 3 is a partial sectional view through the turning bar 01 from FIG. 1 in the area identified by III in FIG. 1. This partial section shows a portion of the inner structure of the turning bar 01, and in particular one of the two pistons 11, which can be displaced in it. The level of the sectional view is shown by means of the dash-dotted line identified by III in FIG. 2. The holes 08 and the slit 12 in the surface area 01 of the turning bar 01 can be clearly seen in the sectional view.

In FIG. 3, the piston 17 is shown in a view from above to the left of the longitudinal axis X-X of the turning bar 01, and in section to the right of the longitudinal axis. It has the approximate shape of a cup with a bottom 18 and a lateral wall 19, whose edge facing the interior chamber 21 is formed by two helically shaped sections 22, 23, each with an opposite direction of turning. In the position of the piston 17 represented here, the section 22 facing the holes 08 has a right-handed direction of turning, and the section 23 facing the slit 12 has a left-handed direction of turning.

In this orientation of the piston 17, the edge area 22 extends exactly parallel in respect to a web edge 11, which is shown looped around the turning bar 01 in its position shown in solid lines in FIG. 1.

In order to be able to bring the course of the edge section 22 into exact congruence with the web edge 11, an axial displaceability of the piston 17 in the interior of the turning bar 01 is required. A threaded spindle 24 is used for this purpose, which is in engagement with a screw thread in the bottom 18 of the piston 17 and is rotatingly driven by an actuator, for example a motor 36, shown in greater detail in FIG. 5. A second threaded spindle 26, which can be rotatingly driven by the same motor 36, passes through an opening in the bottom 18 without engaging the screw thread. It is in engagement with a screw thread in the bottom 18 of a second piston 17, designed analogously to the piston 17, and is housed diametrically opposite the piston 17 in the turning bar 01.

A rod 27 of square cross section extends along the axis X-X and with little play through an opening in the bottoms 18 of both pistons 17. It is fixedly connected with a gear 44, 46, 27, represented in FIG. 6, and is used for rotating the pistons 17 around the axis X-X in case of pivoting of the turning bar 01 between its two stop positions.

An annular groove 28, in which a ring 29 can be rotated, is formed in the vicinity of the bottom 18 in the lateral wall 19. The ring 29 is fixedly connected with the already mentioned rod 13 on which the detector holder 14 is arranged. It is possible by means of the ring 29 to turn the piston 17 around the axis X-X without the detector holder 14 having to follow this rotating movement. Furthermore, a sealing strip 31, which extends over the entire length of the slit 12 which is open toward the interior chamber 21, has been attached to the rod 13.

FIG. 4 shows this arrangement in a sectional view at the height of the line IV-IV in FIG. 1. Over its entire thickness, the sealing strip 31 is inserted into recesses 32 on both sides of the slit 12, so that it does not hinder the rotatability of the pistons 17. A bracket 33 can be attached to the end of the slit 12 facing the connecting piece 06, which maintains the sealing strip 31 pressed against the jacket 02 even when the interior chamber 21 is not charged with pressure and assures in this way that it performs its sealing function as soon as compressed air is introduced into the interior chamber 21.

FIG. 5 shows a section along the longitudinal axis X-X of the turning bar 01 through its end area 34, identified in FIG. 1 by 34. The already mentioned motor 36 is housed in this end area 34 in a chamber, which is delimited in the direction toward the pistons 17 (upward in FIG. 5) by a plate 37. The plate 37 is maintained rotatably in the jacket 02 with the aid of a rolling bearing 38. The rod 27 is engaged, fixed against relative rotation, with the plate 37. The threaded spindles 24, 26 are rotatably extended through the plate 37, and each one has a drive wheel 39, 41 on its end in the interior of the chamber. A wheel 42, which is complementary to the drive wheels 39, 41, has been mounted on the driveshaft 43 of the motor 36. The driveshaft 43 can be displaced in the direction of the longitudinal axis X-X between the position shown in FIG. 5, in which the wheel 42 is in engagement with the drive wheel 39, and an engagement position with the drive wheel 41. Thus, by means of the selective displacement of the driveshaft 43 the motor 36 can be selectively used for displacing either piston 17. The wheels 39, 41, 42 can be friction wheels or gear wheels, to make the engagement of the wheels which each other easier, the drive wheels 39, 41 can be embodied to be frustoconical, and the wheel 42 double-frustoconical.

When the turning bar 01 is pivoted for changing the deflection direction of the web of material 09, this requires, as already stated above, a rotation of the pistons 17 by 180°. The threaded spindles 24, 26 follow this rotation, so that they exchange places in FIG. 5. The motor 36 is not rotated along with this, the engagement of the wheel 42 with one of the drive wheels 39, 41 can be maintained in the course of this rotation in spite of this. It is of course also possible to cause the selective displacement of both pistons 17 with the aid of only one motor 36 with the aid of a different coupling mechanism than the one described above. It is also conceivable to assign each threaded spindle 24, 26 its own motor, which in this case could be attached to the respective end of the turning bar 01 which is adjoined by the piston driven by the motor. This motor can be arranged fixed in place, or in such a way that it follows the rotating movement of the bar.

FIG. 6 shows a drive mechanism for driving a rotation around 180° of the pistons 17 in the case of a pivot movement of the turning bar 01 from one of its work positions into the other. The reference numeral 44 indicates a portion of a gear wheel, or gear wheel segment, housed in the connecting piece 06. This gear wheel, or gear wheel segment, 44 can be arranged fixed in place in the connecting piece 06, but could also be coupled to the position of the turning bar 01 in such a way that it performs a rotation itself in case of a pivot movement of the turning bar 01. This gear wheel, or gear wheel segment, 44 meshes via a helical gearing with a further gear wheel 46, which is rotatable around the longitudinal axis X-X of the turning bar 01 and substantially fills the free cross section of the interior chamber 21 of the turning bar 01. In FIG. 6, this gear wheel 46 is shown in section to the left of the longitudinal axis X-X, and in a view from above to the right of the axis. It is fixedly connected with the rod 27. The threaded spindle 26, which is used for driving the piston 17 at the end of the turning bar 01 facing away from the motor 36, is passed, freely rotatable, through a bore in the gear wheel 46. The threaded spindle 24, which is used for driving the piston 17 adjoining the motor 36, is rotatably seated in the gear wheel 46. The gear wheel, or gear wheel segment, 44 and the gear wheel 46 are laid out in such a way that they convert a pivot movement of the turning bar 01 by 90° around the axis of the joint 04 into a rotation by 180° of the gear wheel 46, and therefore of the pistons 17. In this way the gear 44, 46, 27 shown in FIG. 6 assures that the pistons 17 are in a rotation orientation respectively matched to each one of the two working positions of the turning bar 01.

To match the turning bar 01 to the guidance of a fresh web of material 09, it is possible to proceed as follows, for example. First, the pistons 17 are displaced into their stop positions adjoining the respective ends of the turning bar 01. In this position the detectors are not located opposite a web of material 09 guided over the turning bar 01. A signal level supplied by the detector unit in this state is considered to be a “prohibited” level. Thereafter, each of the pistons 17 is displaced out of its stop position toward the center of the turning bar 01 until the detector unit of the piston 17 registers a web edge 11 and changes its output signal to a “permitted” level. Since in each of the two working positions of the turning bar 01 only one of the two photoelectric cells 16 of each detector unit can lie opposite only one web edge 11, it suffices for evaluating the detector signal to evaluate an OR-linkage of the signals generated by the two photoelectric cells 16 of each detector unit for detecting that the web edge 11 has been detected by the detector unit. To increase the detection assurance it can also be provided that, depending on the working position of the turning bar 01, only one of the two photoelectric cells 16 of each detector unit is operated. A control circuit for performing this task is not separately represented in FIG. 6.

When the position of the detector unit in the detector holders 14, 15 has been correctly adjusted, at the moment at which the detector unit registers the web edge 11, the position of the edge section 22 or 23 of the piston 17 facing the outside of the jacket 02 exactly corresponds to the course of the edge 11 of the web of material 09 on the turning bar 01. Thus, the two pistons 17 cut off all those holes 08 on the jacket 02 of the turning bar 01 from the compressed air supply out of the interior chamber 21, which are not covered by the web of material 09; however, it is possible to generate a homogeneous air cushion over the entire surface under the web of material 09.

FIG. 7 shows a sectional view through the end area of the turning bar 01 in accordance with a second embodiment of the invention. The position of the section is the same as in FIG. 5. Elements which correspond in their shape or function to elements in the above described exemplary embodiment have been provided with the same reference symbols. In this case, the plate 37 is connected, fixed against relative rotation, with the jacket 02, the rod 27 is rotatably seated on the plate 37. Via the wheels 42, 39, the motor 36 drives only one spindle 26 of one of the pistons 17; a corresponding motor for the other piston is located at the other end of the turning bar 01. A wheel 48 acting through a slit 47 in the jacket 02 is in engagement with the wheel 42; it transmits a rotation of the motor 36 to a threaded spindle 49, which is maintained outside of the turning bar 01 parallel with the latter. This threaded spindle 49 drives a detector holder (not represented in FIG. 7), such as the detector holder 14 in FIG. 1, to make a movement coupled to the movement of the piston 17.

FIG. 8 shows a third embodiment of the turning bar 01 in cross section. The essential difference between the above described embodiment and the embodiment in accordance with FIG. 7 is the arrangement of the detectors. The detectors can again be photoelectric cells 16, for example. In the embodiment in accordance with FIG. 8, these photoelectric cells 16 are arranged in the interior of the turning bar 01, they are respectively embedded in the lateral wall 19 of the cylinders 17, each in the vicinity of the edge section 22, 23, so that they can detect the presence of the web 09 as long as the detectors are located in front of one of the holes 08. Although with this embodiment the accuracy with which the position of the web edge 11 can be detected is limited by the distance of the holes 08 in the axial direction, this does not interfere with the functionality of the device, since the piston 17 in the interior of the turning bar 01 can be displaced by just this distance without the number of the open or blocked holes being changed by this.

With this embodiment a flow sensor in particular can be employed, which registers the flow of air from the interior chamber 21 to the outside when it passes a hole 08 which is not covered by the web of material 09.

FIG. 9 shows a schematic representation of turning bars 01 and their control. A plurality of turning bars 01 which are arranged, for example, following a cutting device, in which a web of material 09, in particular an imprinted paper web 09, is cut into a plurality of partial webs 09, each of which is deflected by a turning bar 01. The position of the individual rotating cutters 51 of the cutting device can be set at a control console 54. A control signal indicating the desired position of each cutter 51 is supplied to actuating units (not represented) of the cutters 51 via a signal line 52. This control signal, which simultaneously also defines the position of the edges 11 of the partial webs 09 cut by the cutters 51, is branched off to a control circuit 53 which calculates from this, taking into consideration the positions of the turning bars 01—which can be displaced transversely to the web direction—, the respective desired positions of the cylinders in the interior of the turning bars 01 and actuates their motors in order to take up this desired position.

Alternatively the control signal could also be obtained with the aid of position detectors, which measure the position of the cutters 51, or of the web edges 11 created by them, in the cutting direction.

In order to set the desired position calculated in this way, the control circuit can maintain the actual position of each individual cylinder in a memory, calculate the difference between both positions and operate each motor at a known rotational speed until the piston should have changed from the actual position into the desired position.

It is alternatively possible to provide an operating state of the control circuit in which, for matching a changed web width or a changed position of the turning bars, each piston initially moves into a stop position. Once this has been reached, a change into a control state is made, in which the control circuit, starting at this exactly known stop position, arrives at the desired position by means of operating the motor for a calculated angle of rotation or a calculated time at a known rotational speed.

List of Reference Symbols

01 Guide roller, turning bar

02 Jacket

03 Support arm

04 Joint

05 -

06 Connecting piece

07 Stop

08 Holes

09 Web of material

10 -

11 Edge (09)

12 Slits

13 Rod, support

14 Detector holder

15 Detector holder

16 Photoelectric cell

17 Blocking element, piston

18 Bottom

19 Lateral wall

20 -

21 Interior chamber

22 Edge section

23 Edge section

24 Threaded spindle

25 -

26 Threaded spindle

27 Rod

28 Annular groove

29 Ring

30 -

31 Sealing strip

32 Recess

33 Bracket

34 End area

35 -

36 Actuator, motor

37 Plate

38 Rolling bearing

39 Drive wheel

40 -

41 Drive wheel

42 Wheel

43 Driveshaft

44 Gear wheel/segment (06)

45 -

46 Gear wheel

47 Slit

48 Wheel

49 Threaded spindle

50 -

51 Cutter

52 Signal line

53 Control circuit

54 Control console

l Length

X-X Longitudinal axis

1. A guide roller (01) for guiding a web of material (09), having a jacket (02), which is provided with holes (08) on at least a portion of its circumference, and an interior chamber (21) supplied with compressed air, wherein at least one blocking element (17) is arranged for the selective blockage of the holes (08), characterized in that at least one actuator (36) is arranged for positioning the blocking element (17) in a defined desired position, which is a function of a position of an edge of the web of material (09).

2. The guide roller (01) in accordance with claim 1, characterized in that the blocking element (17) is embodied as an axially displaceable piston (17).

3. The guide roller (01) in accordance with claim 1, characterized in that the actuator (36) is embodied as a motor (36):

4. The guide roller (01) in accordance with claim 1, characterized in that the guide roller (01) is embodied as a turning bar (01).

5. The guide roller (01) in accordance with claim 1, characterized in that a control circuit (53) is provided, that a control signal of the control circuit (53) is a quantitative signal, and that the control circuit (53) operates the actuator (36) until a rotatory travel corresponding to the control signal has been performed.

6. The guide roller (01) in accordance with claim 1, characterized in that the control signal is a signal with two discrete states, and that, if the control signal contains a prohibited state, the control circuit (53) operates the actuator (36) until the control signal makes a transition into a permitted state.

7. The guide roller (01) in accordance with claim 5 or 6, characterized in that the control circuit (53) has an operating state for displacing the piston (17) into an end position, which is independent from the control signal.

8. The guide roller (01) in accordance with claim 6, characterized in that a detector, which can be displaced coupled to the piston (17), provides the control signal.

9. The guide roller (01) in accordance with claim 8, characterized in that the detector comprises a photoelectric cell (16).

10. The guide roller (01) in accordance with claim 8 or 9, characterized in that the detector is mounted on the piston (17).

11. The guide roller (01) in accordance with claim 10, characterized in that the jacket (02) of the guide roller (01) has a slit (12), and that the detector is arranged outside of the jacket (02) and is connected with the piston (17) by means of a support (13) passed through the slit (12).

12. The guide roller (01) in accordance with claim 11, characterized by a sealing tape (31), which is pressed against the edges of the slit (12) by means of the air pressure in the interior chamber (21).

13. The guide roller (01) in accordance with claim 12, characterized in that the sealing tape (31) is coupled to the piston (17) and can be displaced in front of the slit (12).

14. The guide roller (01) in accordance with claim 10, characterized in that the detector (16) is attached inside the piston (17) for detecting the presence or absence of the web of material (09) in front of one of the holes (08).

15. The guide roller (01) in accordance with one of the preceding claims, characterized in that the guide roller (01) can be pivoted on a frame by 90° around a pivot axis extending transversely to its longitudinal axis.

16. The guide roller (01) in accordance with claim 15, characterized in that the piston (17) is rotatable around the longitudinal axis of the guide roller (01) with a gear (44, 46) for coupling the rotary movement of the piston (17) with the pivot movement of the guide roller (01).

17. The guide roller (01) in accordance with claim 16, characterized in that the gear (44, 46) converts the 90° pivot movement of the guide roller (01) into a 180° rotation of the piston (17).

18. The guide roller (01) in accordance with claim 16 or 17, characterized in that the gear (44, 46) comprises a crown gear (46), which is rotatable around the longitudinal axis (X-X) and meshes with teeth (44) which are fixed in place relative to the pivot axis.

19. The guide roller (01) in accordance with claim 18, characterized in that the stationary teeth (44) engage the crown gear (46) arranged inside the jacket (02) through a slit in the jacket (02).

20. The guide roller (01) in accordance with one of claims 16 to 18, characterized in that the gear comprises a non-circular rod (27), on which the piston (17) is fixed against relative rotation and is axially displaceable.

21. The guide roller (01) in accordance with one of claims 16 to 20, characterized in that the actuator (36) can be rotated together with the piston (17).

22. The guide roller (01) in accordance with one of claims 16 to 21, characterized in that a second gear for converting a rotation of the actuator (36) into a displacement of the piston (17) comprises a first wheel (42), which is arranged on the longitudinal axis (X-X) and coupled to the motor shaft (43) and a second wheel (39), which is non-positively connected with the first wheel (42) and is rotatable, coupled to the rotary movement of the piston (17), on an arc of a circle around the first wheel (42).

23. The guide roller (01) in accordance with one of the preceding claims, characterized in that two pistons (17), each with an associated actuator (36), are mounted at opposite ends of the guide roller (01).

24. The guide roller (01) in accordance with one of claims 1 to 22, characterized in that the actuator (36) can be selectively connected with two pistons (17).

25. The method for adjusting a guide roller (01) in accordance with claim 5, characterized in that the control signal is obtained by measuring a position of a device (51) defining an edge (11) of the web of material (09).

26. A method for adjusting a guide roller (01), wherein at least one blocking element (17) for blocking the holes is moved, characterized in that the blocking element (17) is moved by means of an actuator (36) as a function of the position of an edge (11) of the web of material (09).

27. The method in accordance with claim 25 or 26, characterized in that the device defining the edge (11) of the web of material (09) is a cutting device (51).

28. The method in accordance with claim 26, characterized in that the blocking element (17) is displaced as a function of a device (51) defining the edge (11) of the web of material (09).

29. The method in accordance with claim 26, characterized in that the position of an edge (11) of the web of material (09) is determined by means of a sensor.

30. The method in accordance with claim 26, characterized in that the position of an edge (11) of the web of material (09) is predetermined as the desired value from a memory device.
